(19) United States
(12) Patent Application Publication
(10) Pub. No.: US 2016/0057822 A1
(43) Pub. Date: Feb. 25, 2016

(54) DRIVING CIRCUIT, LIGHTING DEVICE AND METHOD OF REDUCING POWER DISSIPATION

(71) Applicant: ABBEYDORNEY HOLDINGS LTD., Grand Cayman (KY)

(72) Inventor: Hezhang Chu, Shenzhen City (CN)

(21) Appl. No.: 14/396,734

(22) PCT Filed: Aug. 19, 2014
(86) PCT No.: PCT/CN2014/084741

§ 371 Date: Oct. 23, 2014

(51) Int. Cl. H05B 33/08; H02M 1/42; H02M 3/335

(52) U.S. Cl. CPC H05B 33/0815; H02M 3/33507; H05B 33/0851; H02M 1/4208

(57) ABSTRACT

A driving circuit comprises a transformer, a first capacitor and a first controller. The transformer includes a primary winding and a secondary winding. The secondary winding is located in a secondary side and configured to generate a power. The first capacitor is connected in series to the primary winding, wherein the first capacitor and the transformer are configured to form a resonance unit. The first controller is configured to obtain a feedback current from the secondary side, and change a working frequency of the resonance unit based on the feedback current so as to change the power.

### TECHNICAL FIELD

The present disclosure relates to a driving circuit, and more specifically, but not exclusively limited to a driving circuit, lighting device and method for reducing power dissipation.

### BACKGROUND

Conventional LEDs operating under a constant current do not emphasize solving thermal power dissipation of the LEDs. The heat generated by LEDs is dissipated via heat dissipation devices made from metals with excellent heat conductivity. LEDs positioned in different environments will eventually reach thermal equilibrium with the ambient air. High thermal power dissipation results in the LEDs working at a high temperature, which, in turn, results in a negative impact on the service life of the LEDs, which causes a reduction of their working reliability and a waste of energy. Furthermore, many metals will be consumed in heat dissipation elements for heat dissipation. Thus, there exists the need for a new driving circuit and devices to overcome the heat dissipation of LEDs.

### SUMMARY OF THE INVENTION

An embodiment of the invention discloses a driving circuit which comprises a transformer, including a primary winding and a secondary winding; the secondary winding is located on a secondary side and configured to generate power; a first capacitor is connected in series to the primary winding, wherein the first capacitor and the transformer are configured to form a resonance unit; one controller is configured to obtain a feedback current from the secondary side, and change the working frequency of the resonance unit based on the feedback current, so as to change the power.

Alternatively, the driving circuit further comprises a first MOSFET and a second MOSFET, wherein the first MOSFET and the second MOSFET are configured to be alternately on and to control the resonance unit to charge or discharge with the changed working frequency.

Alternatively, a gate of the first MOSFET is connected to a first output port of the first controller, a gate of the second MOSFET is connected to a second output port of the controller, a drain of the first MOSFET is connected to an input voltage, a source of the first MOSFET is connected to both a drain of the second MOSFET and the primary winding, a source of the second MOSFET is connected to ground, wherein the first output port and second output port of the first controller are configured to output a complementary square wave.

Alternatively, the first controller is further configured to obtain a working current of the resonance unit, and change the working frequency of the resonance unit based on the feedback current and the working current.

Alternatively, the first controller is further configured to obtain a change of input voltage, and change the working frequency of the resonance unit based on the feedback current, the change of the input voltage and the working current.

Alternatively, the driving circuit further comprises a second capacitor connected between a connection point of the primary winding and the first capacitor and a first input port of the first controller, the second capacitor being configured to detect the working current.

Alternatively, the secondary side further comprises a first rectifier connected to the secondary winding, and the first rectifier is configured to cut off the power when a voltage on the first rectifier is lower than a first voltage threshold, wherein the first rectifier comprises a Metal-Oxide-Semiconductor Field Effect Transistor.

Alternatively, the secondary side further comprises a second controller; configured to turn on the first rectifier if the voltage during a duration is larger than a second voltage threshold, and the duration is larger than a time threshold.

Alternatively, the second controller further comprises a timer, a RS trigger, a first comparator, a second comparator, a third comparator, and an amplifier, wherein one input port of each of the first comparator, the second comparator and the third comparator is configured to receive an input voltage, the other input port of the first comparator, the second comparator and the third comparator is configured to obtain a third voltage threshold, a fourth voltage threshold, and a fifth voltage threshold respectively, wherein an output port of the first comparator is connected to a S port of the RS trigger, an output port of the second comparator is connected to a R port of the RS trigger, an output port of the third comparator is connected to a first input port of the amplifier, an input port of the timer is connected to a Q port of the RS trigger, a first output port of the timer is connected to a control port of the RS trigger, a second output port of the timer is connected to a second input port of the amplifier.

Alternatively, the secondary side further comprises a first diode, a third capacitor, wherein an anode of the first diode is connected to a first tap of the secondary winding, the third capacitor is connected between a cathode of the first diode and a second tap of the secondary winding, and the first rectifier is connected to a connection point of the second tap and the third capacitor.

Alternatively, the secondary side further comprises a second rectifier connected to the secondary winding, wherein the first rectifier and the second rectifier are alternately on to perform a full wave rectification.

Alternatively, the driving circuit further comprises an optocoupler connected between the secondary side and the first controller, wherein the optocoupler is configured to provide the feedback current.

Alternatively, the driving circuit further comprises a third rectifier configured to rectify an alternate input current to direct current; a power factor controller connected to the third rectifier and configured to adjust a power factor of the driving circuit.

Another embodiment of the invention discloses a lighting device, comprising a driving circuit, which comprises a transformer, a primary winding and a secondary winding; the secondary winding is located on a secondary side and configured to generate power; a first capacitor is connected in series to the primary winding, wherein the first capacitor and the transformer are configured to form a resonance unit—a first controller configured to obtain a feedback current from the secondary side, and change the working frequency of the resonance unit based on the feedback current; and wherein the resonance unit is configured to oscillate on the changed working frequency so as to output that changed power; a plurality of LED elements connected to the secondary side of the driving circuit, wherein the LED elements work in a range between about a normal working current and about a peak pulse current.

Alternatively, the normal working current comprises rated working current.

Alternatively, the LED elements work at about the peak pulse current.

Alternatively, the plurality of LED elements are arranged in columns, and the columns are connected in parallel.

Alternatively, the lighting device further comprises a second controller configured to control the columns of LED elements to light in turns.

Alternatively, the driving circuit further comprises a first MOSFET and a second MOSFET, wherein the first MOSFET and the second MOSFET are configured to be alternately on and to control the resonance unit to charge or discharge with the changed working frequency.

Alternatively, a gate of the first MOSFET is connected to a first output port of the first controller, a gate of the second MOSFET is connected to a second output port of the controller, a drain of the first MOSFET is connected to an input voltage, a source of the first MOSFET is connected to both a drain of the second MOSFET and the primary winding, a source of the second MOSFET is connected to ground, wherein the first output port and second output port of the first controller are configured to output complementary square wave.

Alternatively, the first controller is further configured to obtain a working current of the resonance unit, and change the working frequency of the resonance unit based on the feedback current and the working current.

Alternatively, the first controller is further configured to obtain a change of input voltage, and change the working frequency of the resonance unit based on the feedback current, the change of the input voltage and the working current.

Alternatively, the driving circuit further comprises a second capacitor connected between a connection point of the primary winding and the first capacitor and a first input port of the first controller, the second capacitor being configured to detect the working current.

Alternatively, the secondary side further comprises a first rectifier connected to the secondary winding, and the first rectifier is configured to cut off the power when a voltage on the first rectifier is lower than a first voltage threshold, wherein the first rectifier comprises a Metal-Oxide-Semiconductor Field Effect Transistor.

Alternatively, the secondary side further comprises a third controller, configured to turn on the first rectifier if the voltage during a duration is larger than a second voltage threshold, and the duration is larger than a time threshold.

Alternatively, the third controller further comprises a timer, a RS trigger, a first comparator, a second comparator, a third comparator, and an amplifier, wherein one input port of each of the first comparator, the second comparator and the third comparator is configured to receive an input voltage, the other input port of the first comparator, the second comparator and the third comparator is configured to obtain a third voltage threshold, a fourth voltage threshold, and a fifth voltage threshold respectively, wherein an output port of the first comparator is connected to a S port of the RS trigger, an output port of the second comparator is connected to a R port of the RS trigger, an output port of the third comparator is connected to a first input port of the amplifier, an input port of the timer is connected to a Q port of the RS trigger, a first output port of the timer is connected to a control port of the RS trigger, a second output port of the timer is connected to a second input port of the amplifier.

Alternatively, the secondary side further comprises a first diode, a third capacitor, wherein an anode of the first diode is connected to a first tap of the secondary winding, the third capacitor is connected between a cathode of the first diode and a second tap of the secondary winding, and the first rectifier is connected to a connection point of the second tap and the third capacitor.

Alternatively, the secondary side further comprises a second rectifier connected to the secondary winding, wherein the first rectifier and the second rectifier are alternately on to perform a full wave rectification.

Alternatively, the driving circuit further comprises an optocoupler connected between the secondary side and the first controller, wherein the optocoupler is configured to provide the feedback current.

Alternatively, the driving circuit further comprises a third rectifier configured to rectify an alternate input current to direct current; a power factor controller connected to the third rectifier and configured to adjust a power factor of the driving circuit.

Another embodiment of the invention discloses a driving method, comprising: generating a power by a transformer including a primary winding and a secondary winding, which is located on the secondary side; oscillating by a capacitor and the transformer at a working frequency; obtaining a feedback current from the secondary side, changing the working frequency based on the feedback current; and changing the power based on the changed working frequency.

Alternatively, the method further comprises obtaining a working current of the resonance unit, and changing the working frequency of the resonance unit based on the feedback current and the working current.

Alternatively, the method further comprises obtaining a change of input voltage, and changing the working frequency of the resonance unit based on the feedback current, the change of the input voltage and the working current.

Alternatively, the method further comprises converting feedback voltage to the feedback current with optocoupler; obtaining working current with detection capacitor; determining whether the working current is larger than a current-limiting threshold; changing the working frequency of the resonance unit according to the feedback current if not larger than the current-limiting threshold; increasing the working frequency so as to reduce output voltage if larger than the current-limiting threshold.

Another embodiment of the invention discloses a method of controlling LED device, comprising: detecting the temperature of the LED device; determining the off time in a cycle of the LED device based on the temperature; and switching the LED device on and off periodically, wherein the LED device is off for the determined off time in each cycle.

Alternatively, the method further comprises supplying a voltage to the LED device, such that the LED device works in a range between about a normal working current and about a peak pulse current.

Alternatively, the method further comprises supplying a voltage to the LED device, such that the LED device works at about the peak pulse current.

Another embodiment of the invention discloses a computer-readable medium containing instructions that, when executed by a processor, are configured for performing: detecting the temperature of the LED device; determining the off time in a cycle of the LED device based on the temperature; and switching the LED device on and off periodically, wherein the LED device is off for the determined off time in each cycle.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims. In the drawings, the identical reference signs represent the same elements.

FIG. 1 is a device block diagram illustrating an embodiment of the driving circuit.

FIG. 2 is a circuit diagram illustrating another embodiment of the driving circuit.

FIG. 3 is a circuit diagram illustrating another embodiment of the driving circuit.

FIG. 4 is a circuit diagram illustrating another embodiment of the driving circuit.

FIG. 5 is a circuit diagram illustrating another embodiment of the driving circuit.

FIG. 6 is a circuit diagram illustrating another embodiment of the driving circuit.

FIG. 7 is a diagram of an embodiment of a sensing circuit for the secondary output voltage and the FB feedback pin.

FIG. 8 is a circuit diagram illustrating an embodiment of the rectifier circuit.

FIG. 9 is an internal block diagram of the chip IC3 and IC4 shown in FIG. 8.

FIG. 10 is a block diagram illustrating an embodiment of the lighting circuit.

FIG. 11 is a block diagram illustrating an embodiment of the LED circuit.

FIG. 12 is a circuit diagram illustrating an embodiment of the LED device including a driving circuit.

FIG. 13 is a flow chart illustrating an embodiment of a driving method.

FIGS. 14A and 14B are flow charts illustrating an embodiment of a method of light controlling.

FIG. 15 is a method flow chart illustrating a method of controlling chip U1.

FIG. 16 is a method flow chart illustrating another method of controlling chip U1.

FIG. 17A is an equivalent circuit diagram illustrating the LC series resonance circuit.

FIG. 17B is a graph illustrating a test of resonance gain.

FIG. 18 is a diagram illustrating an embodiment of the waveform of the LC series resonance circuit.

### DETAILED DESCRIPTION

Various examples of the invention will now be described. The following description provides specific details for a thorough understanding and enabling description of these examples. One skilled in the relevant art will understand, however, that the invention may be practiced without many of these details. Additionally, some well-known structures or functions may not be shown or described in detail below, so as to avoid unnecessarily obscuring of the relevant description.

Driving the LED devices is only one application of the embodiment of the driving circuit. The embodiments of the invention can also be applied to audio amplifier, power supply for printer, power supply for LCD TV, or any other electrical device.

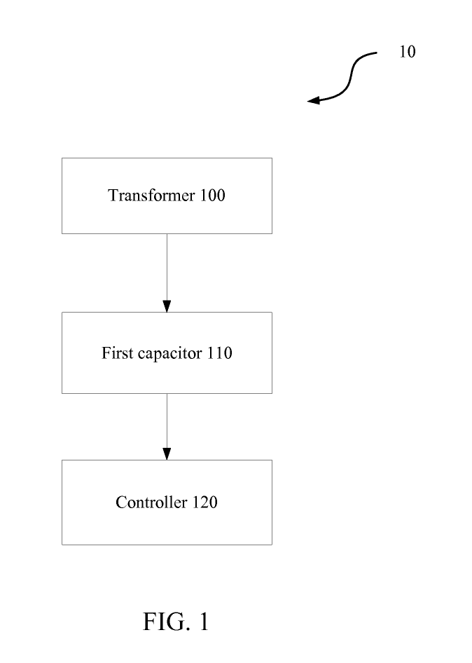

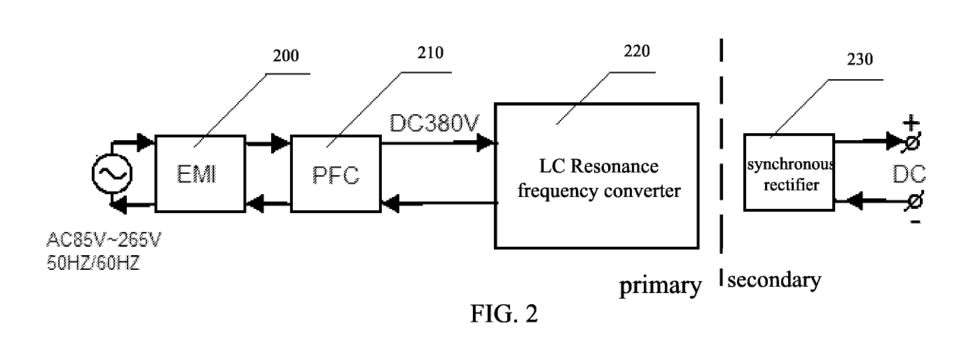

FIG. 1 is a device block diagram illustrating an embodiment of the driving circuit. The driving circuit 10 comprises a transformer 100, a first capacitor 110 and a controller 120. The transformer 100 includes a primary winding and a secondary winding, and the secondary winding is configured to generate a power. The secondary winding is located at a second side. The primary winding and the secondary winding will be specifically described in FIG. 2. The first capacitor 110 is connected in series to the primary winding, wherein the first capacitor 110 and the transformer 100 are configured to form a resonance unit. The controller 120 is configured to obtain a feedback current from the secondary side, and changes the working frequency of the resonance unit based on the feedback current. The resonance unit operates at a changed working frequency, such that the output power is changed. Alternatively, the controller 120 is also configured to obtain the working current of the primary winding, that is, the working current of the resonance unit, and changes the working frequency of the resonance unit based on the feedback current and the working current of the resonance unit. Alternatively, the controller 120 is also configured to obtain the change of input voltage, and changes the working frequency of the resonance unit based on the feedback current, the change of the input voltage and the working current.

FIG. 2 is a circuit diagram illustrating another embodiment of the driving circuit. The driving circuit includes a bi-directional passive EMI (Electro Magnetic Interference) suppressor 200, a boost power factor controller PFC 210, an LC resonance frequency converter 220 and a synchronous rectifier 230. The LC resonance frequency converter 220 and the synchronous rectifier 230 will be described in more detail below.

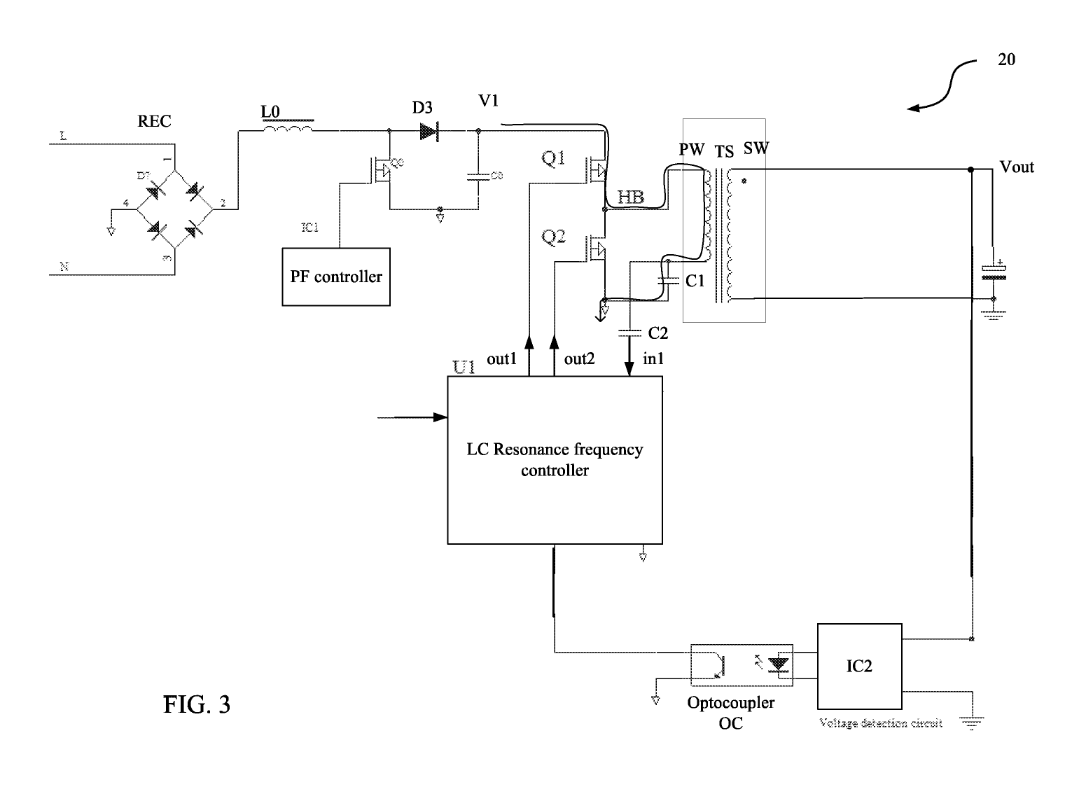

FIG. 3 is a circuit diagram illustrating an embodiment of the driving circuit. The driving circuit 20 comprises a transformer TS, a first capacitor C1 and a controller U1, and further comprises a first MOSFET Q1 and a second MOSFET Q2. The transformer TS includes a primary winding PW and a secondary winding SW. The first MOSFET Q1 and the second MOSFET Q2 are configured to be alternately on and control the resonance unit to charge or discharge.

The controller U1 includes multiple outputs, for example, a first output port out1 and a second output port out2. A gate of the first MOSFET Q1 is connected to the first output port out1 of the controller U1, and a gate of the second MOSFET Q2 is connected to the second output port out2 of the controller U1. A drain of the first MOSFET Q1 is connected to a power supply voltage V1. For example, V1 may be 380 VDC (direct current). A source of the first MOSFET Q1 is connected to both a drain of the second MOSFET Q2 and the primary winding. A source of the second MOSFET Q2 is connected to ground, wherein the first output port and second output port of the controller U1 are configured to output complementary square wave.

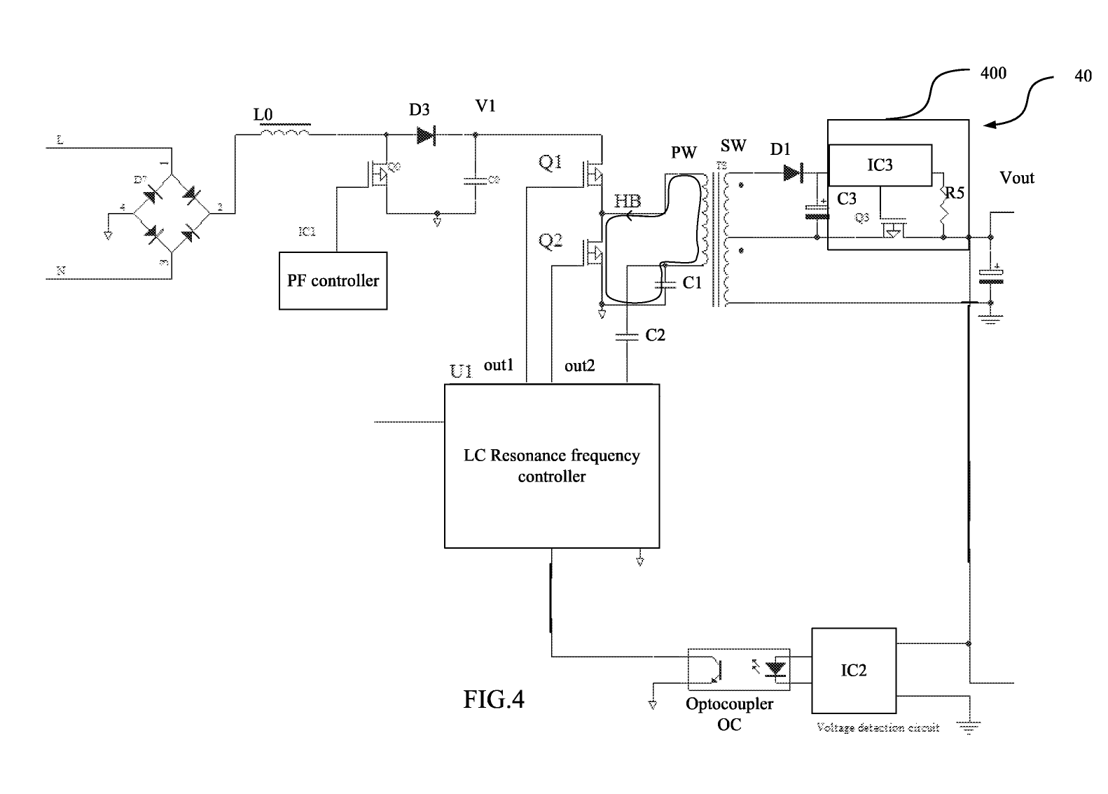

When the first MOSFET Q1 is on and the second MOSFET Q2 is off, a current path is shown in FIG. 3. A power supply V1 flows through the transformer TS via the first MOSFET Q1 to charge the capacitor C1 and therefore the electrical energy is stored in the first capacitor C1. When the second MOSFET Q2 is on and the first MOSFET Q1 is off, a current path is shown in FIG. 4. The electrical energy stored in the first capacitor C1 is discharged through the transformer TS. The transformer TS and the first capacitor C1 form a resonance circuit. The resonance frequency f_{R} of the resonance circuit, also called local frequency, can be represented as

$${f}_{R} = \frac{1}{2 π \sqrt{{L}_{L} \times {C}_{1}}} = \frac{1}{6.28 \sqrt{{L}_{L} \times {C}_{1}}}$$

In the above expression, f_{R} is the series resonance frequency (Hz), L_{L} is the leakage inductance (H) of the transformer TS, and C₁ is the value of the resonance capacitor C1 (F). In the actual application, the maximum variable frequency may be 0.8 f_{R}.

The controller U1 changes the switching frequency of the first MOSFET Q1 and the second MOSFET Q2 by changing the frequency of the output square wave of the first output port and the second output port. Thus the working frequency of the resonance unit changes accordingly. That is, the charge and discharge periods of the resonance unit which comprises the first capacitor C1 and the transformer TS are also changed. Therefore the induced electrical energy induced by the secondary winding SW of the transformer TS changes accordingly. As a result, power provided by the secondary winding SW of the transformer TS changes consequently.

As shown in FIG. 3, the driving circuit 20 further comprises a second capacitor C2 connected between a connection point of the primary winding PW and the first capacitor C1 and a first input port in1 of the controller U1 and configured to detect the working current of the resonance unit.

FIG. 3 also shows an optocoupler OC connected between the secondary winding SW and the controller U1. The optocoupler OC is configured to provide the feedback current. The left side of the optocoupler OC is a phototransistor and the right side is a light emitting diode (LED). The light emitting diode (LED) converts an electrical signal representing a voltage of the secondary side into an optical signal. The phototransistor detects an incident optical signal and generates a current corresponding to the voltage of the secondary side. The optocoupler may be a linear optocoupler. The higher the voltage on the secondary side, the larger the current generated by the optocoupler OC.

The driving circuit 20 shown in FIG. 3 further comprises a third rectifier REC. The third rectifier REC is configured to rectify an alternate input current to direct current. As shown in FIG. 3, the REC can be implemented as a bridge. The driving circuit 20 further comprises a power factor controller configured to be connected to the third rectifier REC and adjust a power factor of the driving circuit.

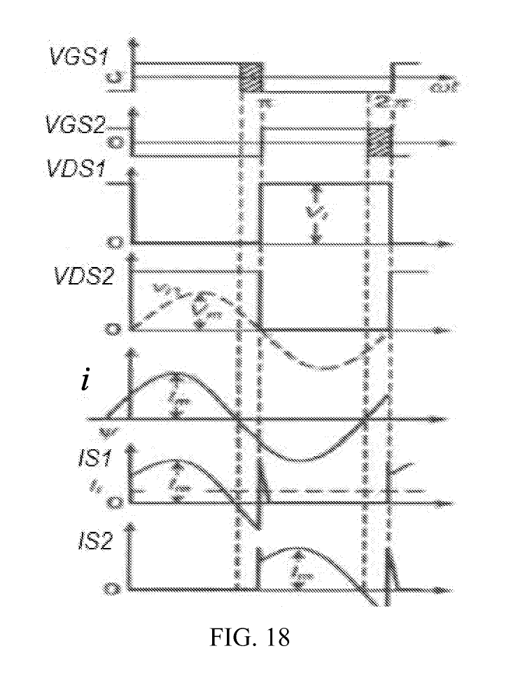

FIG. 18 is a diagram illustrating an embodiment of the waveform of the LC series resonance circuit.

The voltage of the first output port out1 of U1 can be expressed as VGS1, and the voltage of the second output port out2 of U1 can be expressed as VGS. As shown in FIG. 18, the square-waves outputted by the first output port and the second output port are complementary. Therefore, the gate voltages of the first MOSFET Q1 and the second MOSFET Q2 are opposite. When the first output port outputs VGS1 at a high voltage level, the second output port outputs VGS2 at a low voltage level. Conversely, when the first output port outputs VGS1 at a low voltage level, the second output port outputs VGS2 at a high voltage level. Therefore, the first MOSFET Q1 and second MOSFET Q2 are alternately on. From FIG. 18, it can be seen that there is a gap between rising and falling edges of VGS1 and VGS2, so as to avoid Q1 and Q2 being on at the same time, and destroy the circuit. From FIG. 18, it can also be seen that the voltage output by U1 is a pulse sequence in square wave, but the LC resonance current is harmonic wave. 151 represents the source current of Q1, and 152 represents the source current of Q2.

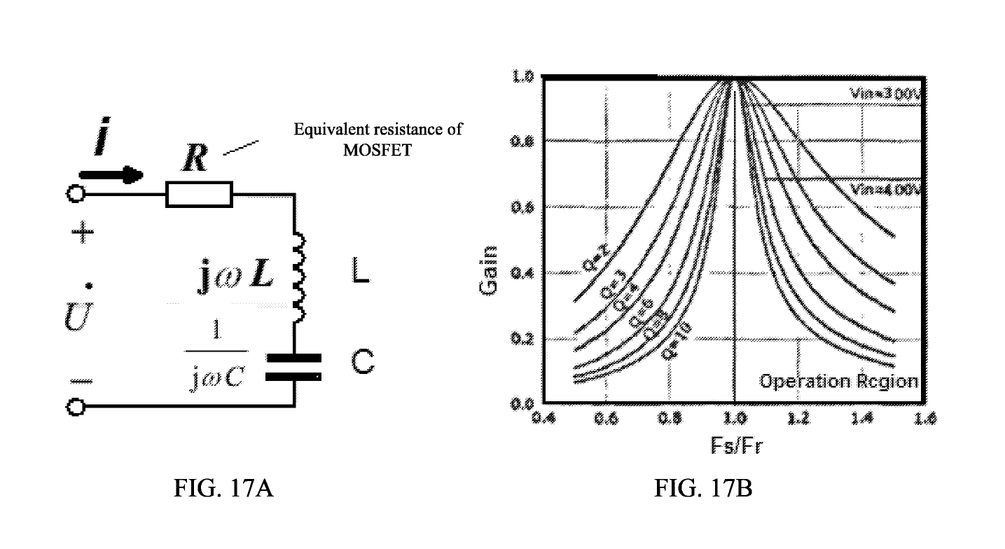

FIG. 17A is an equivalent circuit diagram illustrating the LC series resonance circuit. R represents an equivalent resistance of the MOSFET. L represents an inductor of the transformer. C represents the resonance capacitor.

FIG. 17B is a graph illustrating a test of resonance gain. Fs represents working frequency, and Fr represents the resonance frequency. Fs/Fr represents the ratio of working frequency and resonance frequency. Its maximum value is 1. Optionally, the working frequency Fs may be selected on the right side of the resonance point, as the gains on the right side of the resonance point are higher than the gains on the left side of the resonance point. That is, the operational region may be selected on the right side of the resonance point. Q represents quality factor, and Gain represents gain. When the working frequency Fs varies, gains for resonance voltage or current are different. From the resonance frequency to its right, the higher the frequency, the smaller the gain, thus the output voltage and current are reduced.

According to an embodiment of the present invention, the advantage of designing a driving circuit as a resonance frequency converter includes the minimum thermal power dissipation in transformation, and the output power can automatically match the load of the lighting sets in order to achieve the maximum efficiency. It can be well matched in the circumstances of an open circuit (including standby), short circuit, a maximum load and a proportional load. The design of match between the power circuit and the LED circuit includes a thermal dynamic equilibrium of the circuit during operation, which enables the circuit to work with optimal efficiency, and reduces heat dissipation.

The driving circuit is not limited to driving an LED device; it can also be used for driving electrical or electric equipment such as air conditioners. Further, an embodiment of the drive circuit is an efficient driving power supply. As the embodiments solve the problem of thermal power dissipation of a power supply, the embodiments may also be applied, but not limited to, LED street lamps and outdoor lighting, audio amplifier, printer power supply, LCD TV power supply and other electrical devices.

FIG. 4 is a circuit diagram illustrating another embodiment of the driving circuit 40. Details are omitted for the elements already discussed with respect to FIG. 3. As shown in FIG. 4, the secondary side of the transformer TS further comprises the first rectifier 400 connected to the secondary winding SW. The secondary winding SW is located on the secondary side. The first rectifier 400 is configured to cut off power when a voltage on the first rectifier 400 is lower than a threshold, the threshold may be, for example, about −310 mV. The first rectifier 400 comprises a Metal-Oxide-Semiconductor Field Effect Transistor Q3. As shown in FIG. 4, the secondary side further comprises a first diode D1 and a third capacitor C3, wherein an anode of the first diode D1 is connected to a first tap of the secondary winding SW. The third capacitor C3 is connected between a cathode of the first diode D1 and a second tap of the secondary winding SW. The first rectifier 400 is connected to the connection point of the second tap and the third capacitor C3. A third tap of the secondary winding is connected to ground. As shown in FIG. 4, the first rectifier 400 further includes a rectifier controller IC3 to detect the voltage on the first rectifier 400 and determine whether the voltage on the first rectifier 400 is higher than a threshold—the threshold may be, for example, about −310 mV. If the voltage is higher than the threshold, then Q3 will be on, while if the voltage is lower than the threshold, Q3 will be off. Alternatively, the rectifier controller IC3 can further determine the duration time of the voltage higher than the threshold. If the duration time is greater than a time threshold, for example, about 2 μs, it means that the voltage is an input signal and the rectifier controller IC3 controls the Q3 to be turned on. If the duration time is less than the time threshold, the rectifier controller IC3 will determine that it may be interference, for example, a spike pulse, and Q3 will still be off under the control of the rectifier controller IC3. The secondary side further includes a resistor R5 and is configured to limit the current. The first rectifier 400 performs a half-wave rectification on the output waveform and outputs power discontinuously. Since Q3 is positioned in the main current path and it is a MOSFET, and the internal resistance of the MOSFET when it is on is very small compared to a diode, it can subsequently further reduce the heat dissipation.

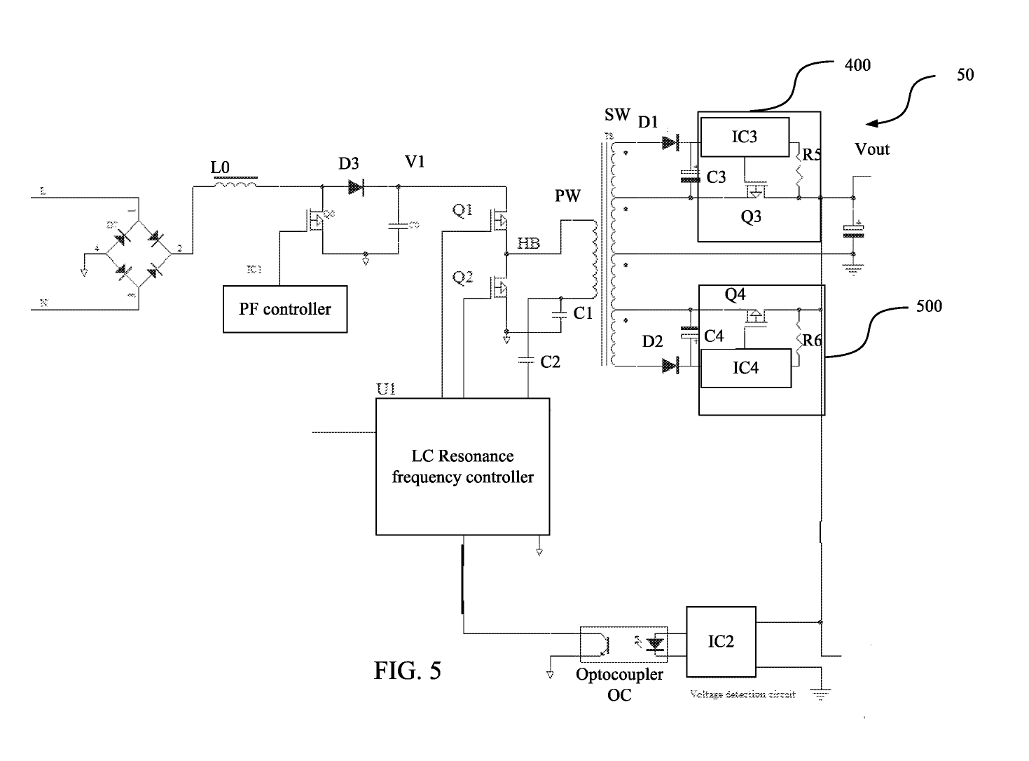

FIG. 5 is a circuit diagram illustrating another embodiment of the driving circuit. A secondary side where the secondary winding SW is located further comprises a second rectifier 500 connected to the secondary winding SW, wherein the first rectifier 400 and the second rectifier 500 are alternately on to perform a full wave rectification. Specifically, the secondary side further comprises a second diode D2, a fourth capacitor C4, wherein an anode of the second diode D2 is connected to a fourth tap of the secondary winding SW. The fourth capacitor C4 is connected between a cathode of the second diode D2 and a fifth tap of the secondary winding SW. The second rectifier 500 is connected to the connection point of the fifth tap and the fourth capacitor C4. As shown in FIG. 5, the second rectifier 500 further includes a rectifier controller IC4 to detect the voltage on the second rectifier 500 and determine whether the voltage on the second rectifier 500 is higher than a threshold, the threshold may be for example, −310 mV. If the voltage is higher than the threshold, Q4 will be on, while if the voltage is lower than the threshold, Q4 will be off. The secondary side further includes a resistor R6 and is configured to limit the current.

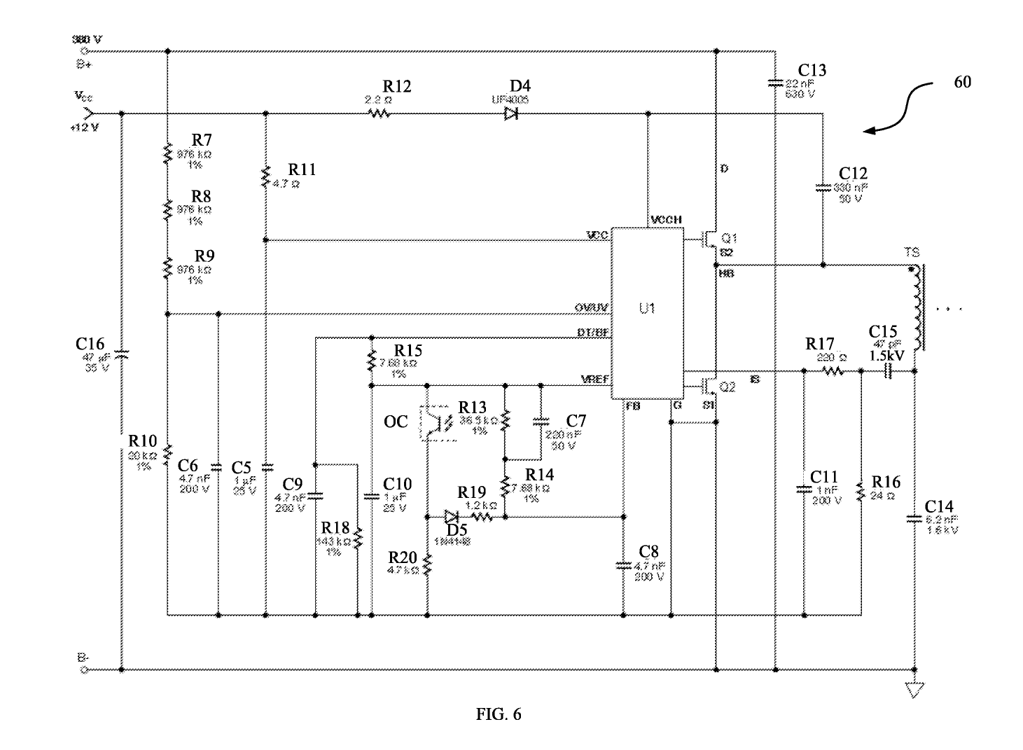

FIG. 6 is a circuit diagram illustrating another embodiment of the driving circuit 60. The output HB of U1 drives output transformer TS through DC blocking capacitor/resonance capacitor C14 (equivalent to the C1 in FIG. 3). TS and resonance capacitor C14 form a primary series resonance circuit and the primary series resonance frequency can be represented as:

$${f}_{R} = \frac{1}{2 π \sqrt{{L}_{L} \times {C}_{14}}} \approx \frac{1}{6.28 \sqrt{{L}_{L} \times {C}_{14}}}$$

In the above expression, f_{R} is the series resonance frequency (Hz), L_{L} is the leakage inductance (H) of the transformer TS, and C₁₄ is the value of the resonance capacitor C14 (F).

Elements D4, R12 and C12 form a boost circuit and supply power to an internal driver of U1 for the upper MOSFET, that is Q1. Elements C16, R11 and C5 provide filter and bypass to the input Vcc (about +12V). The input Vcc (about +12 V) is the VCC power supply of the controller U1, that is an aiding power supply. Voltage dividers R7, R8, R9 and R10 are used for setting the thresholds of high voltage on, off and overvoltage. When the input high voltage overvoltage cut-off point is about 473 VDC, the on-point can be set at about 360 VDC and the cut-off point of the under-voltage is set at about 285 VDC by the selected values of the voltage dividers. The input under-voltage cut-off point can be set at about 280 VDC due to the internal hysteresis characteristics. Capacitor C13 is a about +380V high frequency bypass capacitor.

Capacitors C15 and C14 together form a shunt for sampling a part of the primary current. Resistor R16 can detect the primary current (that is, the current to be fed into IS pin of the controller U1) and the generated signal is filtered by R17 and C11. The rated value of C15 can be determined according to the peak voltage occurred in the fault condition. Capacitor C15 is equivalent to the Capacitor C2 in FIG. 3. The capacitor C15 can be made from stable media with low loss such as metal film, SL ceramics or NP0/C0G ceramics, etc. The used capacitor is a discoid ceramic capacitor with a “SL” temperature characteristic and is usually used for the driver of Cold Cathode Fluorescent Lamp (CCFL). According to the following formula, the selected value can set a current-limiting for one period (high-speed) at about 5.5 A and a current-limiting for seven periods (low-speed) at about 3 A:

I_{CL} is the current-limiting value for seven periods (A), and R16 is the current-limiting resistor (Ohms). C14 and C15 are the value of the resonance capacitor and the current sampling capacitor (nF). As to the current-limiting value for one period, about 0.5 V in above formula can be replaced with about 0.9 V. That is

$${I}_{CL 2} = \frac{0.9}{( \frac{C 15}{C 14 + C 15} ) \times R 16}$$

Resistor R17 and capacitor C11 filter the primary current signal to be transmitted to the IS pin of the controller U1. The resistor R17 may be set at the minimum suggested value of about 220 Ohms (Ω). The set value of the capacitor C11 can be about 1 nF in order to avoid a false triggering caused by noise and the value is insufficient to influence the above-calculated current, limiting set values I_{CL1} and I_{CL2}. Elements of the resistor R17 and the capacitor C11 can be positioned near the IS pin in order to maximize their utility. The IS pin can bear a negative current, therefore the current sensing does not need to adopt a sophisticated rectification scheme.

Resistor R15 is connected to the pin DT/BF of the controller U1. The dead-time DT is set to about 330 nS and the maximum working frequency F_{MAX} of the controller U1 is set to about 773 kHz. C9 filters the input of F_{MAX} of the controller U1. The parallel connection of R15 and R18 can choose the pattern of the pulse train as “one” period for U1. In this way, the lower limit f_{START} and the upper limit f_{STOP} of the threshold frequency of the pulse train can be set to about 338 kHz and about 386 kHz respectively.

The feedback pin FB has the approximate characteristic that each μA current flowing into the feedback pin generates a frequency of about 2.6 kHz. With the increase of the current flowing into the feedback pin FB, the working frequency of U1 is higher correspondingly, thus reducing the output voltage. R13 and R14 connected in series enables the set value of the minimum working frequency of U1 to about 115 kHz. The set value is usually a little bit lower than the required frequency to achieve voltage stabilization under the conditions of full load and the minimum large bulk capacitance voltage.

Resistor R13 is bypassed by C7 to provide a soft start output when starts to work. Its operation mode is as follows: when a feedback loop is open, initially a higher current is allowed to flow into the feedback pin FB. Therefore the working frequency of the controller U1 is higher, which enables Q1 and Q2 with a higher switching frequency at the beginning. Then the switching frequencies of Q1 and Q2 are reduced after the output voltage is stabilized. The set value of resistor R14 is usually the same as the resistor R15 in order that the original frequency of a soft-start is equivalent to the maximum working frequency set by the resistor R15. If the value of R14 is smaller than R15, it will cause a delay during the period between applying an input voltage and starting the switching operation.

The optocoupler OC drives the feedback pin FB of the controller U1 via a resistor R19. The resistor R19 can limit the maximum optocoupler current flowing into the feedback pin FB, which achieves an effect of limiting the current. Capacitor C8 is used to filter the feedback pin FB. Resistor R20 may load the output of the optocoupler in order to force it to work with a relatively higher static current and improve its gain. The resistors R19 and R20 may improve the step response of the signal and the output ripple of the pulse train mode. R20 can be isolated from the network of F_{MAX}/soft-start by a diode D5.

The following part will focus on the basic working principle of U1.

Dead-Time, the Maximum Start-Frequency, and the Threshold Frequency of the Pulse Train

The resonance converter U1 requires a fixed and accurate dead-time during the half-period of switching (avoid shoot-through). The resistor voltage dividers connected among the pin DT/BF, pin VREF and grounding pin G are used for setting dead-time, the maximum start-frequency F_{MAX} and the threshold frequency of the pulse train.

Dead-Time/Pulse Train Frequency Pin (DT/BF)

The pin has the voltage-current (V-I) characteristic of the grounding diode at the same time. The resistor voltage divider connected to the pin VREF and the grounding pin G can set the dead-time, the maximum start-frequency, and the threshold frequency of the pulse train; the maximum start-frequency F_{MAX} is determined by the current flowing into the pin DT/BF through a resistor voltage divider. The ratio of the resistor can be chosen from three independent ratios of the threshold frequency of the pulse train. The three ratios are fixed fractions of F_{MAX}.

Changes in Frequency

The feedback pin FB is the input of frequency control for the feedback loop. The frequency is proportional to the current of the feedback pin FB. The voltage-current (V-I) characteristic of the feedback pin is similar to the grounding diode.

Pulse Train Mode

If the controller U1 determines that the frequency controlled by the current of the feedback pin FB exceeds the upper limit of the pulse train threshold frequency (f_{STOP}) set by the resistor voltage divider on the pin DT/BF, the output MOSFET Q1 and Q2 will be cut off. If the working frequency corresponding to the current of the feedback pin FB is lower than the lower limit of the threshold frequency of the pulse train (f_{START}), the MOSFET Q1 and Q2 will start switching again. Generally, the pulse train mode controlling is similar to a controller with hysteresis characteristics: a progress is repeated that the frequency increases from f_{START} to f_{STOP} and then stops. The minimum and start current of the feedback pin FB is determined by the external circuit connected to the pin VREF and feedback pin FB, thus the minimum and the start frequency f_{START} is determined. The soft-start capacitor in the circuit determines the timing sequence of the soft-start.

Pin VREF

VREF pin provides a reference voltage, for example, about 3.4 V, for the external circuit of the feedback pin FB and other function control circuits. The maximum current provided by the VREF pin must be about 4 mA.

Pin OV/UV

Pin OV/UV detects the output of high voltage B+ through a resistor voltage divider. It performs a voltage ramp up, a voltage ramp down and a function of overvoltage (OV) protection with hysteresis characteristics. The ratios of these voltages are fixed. Users can choose the ratio of the resistor voltage divider and enables the ramp up voltage lower than the minimum stabilized set value for rated large capacitor (input) voltage in order to insure a start.

However, the restart voltage OV (lower protection threshold) is higher than the maximum set value for the rated large capacitor voltage in order to insure of a restart of LC when input voltage fluctuations triggers an upper threshold of OV. If different voltage ramp up—voltage ramp down—OV ratio are needed, an additional external circuit may need to be added around the resistor voltage dividers.

Pin VCC Under Voltage Lock Out (UVLO)

Pin VCC has a function of internal under voltage lock out UVLO and also has hysteresis characteristics. The controller U1 will not start until the pin voltage VCC exceeds the VCC start threshold VUVLO (+). U1 will cut off when VCC drops to the cut-off threshold VUVLO(−) of VCC.

Pin VCCH Under Voltage Lock Out (UVLO)

Pin VCCH is the power supply pin of the upper-side driver. It is similar to the pin VCC and has a UVLO function, but the threshold value is lower than pin VCC. Thus the voltage of VCCH is a little bit lower than VCC, because pin VCCH is powered by VCC through boost diode D4, and a series current-limiting resistor R12.

Start and Restart Automatically

Before start, internal of the chip U1 pulls the voltage of the feedback pin FB up to the pin VREF in order to discharge the soft-start capacitor and keep the output MOSFET Q1 and Q2 off. After start, the internal pull-up transistor is off and the soft-start capacitor charges. The output starts switching operation at F_{MAX}. The current of the feedback pin decreases and the switching frequency falls down. At this time, the output of the power supply goes up.

When the output reaches the set point of voltage, the optocoupler OC is on, which closes the feedback loop and the output is regulated to reach a stabilized voltage. Each time the pin VCC powers on, the pin DT/BF is under a high impedance mode for 500 ms to detect the ratio of the voltage divider and choose the working threshold of the pulse train. Storing these settings until VCC is powered on and the settings need to be chosen again next time. Then the pin DT/BF turns into a normal mode, which is similar to a grounding diode. The sensed current will then set an F_{MAX} frequency. The threshold frequency of the pulse train is the fixed fraction of F_{MAX}. As long as the internal of the chip U1 pulls the voltage of the feedback pin FB up to start, the internal oscillator operates the internal counter at F_{MAX}.

When a malfunction is detected by pin IS, OV/UV or VCC (UVLO), the internal feedback pin FB pulls up the transistor and is on, for example, 131,072 clock periods in order to totally discharge the soft-start capacitor and then try to restart. The first power-on after the power supply circulation of VCC only waits for example 1024 periods, including the situation that the pin OV/UV rises above the threshold of the ramp voltage the first time after VCC powers on.

Remote Shut Off

Remote shut off can be achieved by pulling the OV/UV pin voltage down to the ground or pull the IS pin up to higher than about 0.9V for activation. These two approaches can both activate for example a 131,072 cycle restart cycle.

It can also be achieved by pulling down the VCC to shut off the device, but when the VCC is pulled up, the voltage of feedback pin FB will be pulled up to VREF pin voltage, and the soft start capacitor is discharged for only for example 1024 Fmax clock cycles. If this solution is used, it should be guaranteed at the time that the VCC is pulled down, plus, for example, 1024 cycles are sufficient for the soft start capacitor to discharge, otherwise, it will cause the start frequency to be lower and result in a too large primary current, which may even trigger over-current protection.

Current Sensing

IS pin is used to sense the primary current. It is similar to a diode inversely connected to grounding pin G. It allows a negative voltage, with the condition that the negative current is limited to less than about 5 mA. To this end, IS pin is connected to the current sensing resistor through a series current-limiting resistor of more than 220Ω (for example R17) (or through primary capacitive voltage divider and sensing resistor, such as C11 and R16). Therefore IS pin can accept AC waveform, and does not require a rectifier or peak sensing circuit. If IS pin senses a rated peak forward voltage of about 0.5 V for seven consecutive cycles, the automatic restart will be activated. IS pin also has a higher rated threshold of about 0.9 V, and when a single pulse voltage exceeds this threshold, the automatic restart will be activated. The minimum sensing pulse width to trigger the two voltage thresholds requires a rating of about 30 ns, i.e. normal threshold sensing time should be greater than 30 ns.

The parameters for resistance and capacitance shown in FIG. 6 are as below. The following values are only for example, and those of ordinary skill in the art can select other values according to the actual practical application.

| | |
|---|---|
| Value | Accuracy |

| | | | |
|---|---|---|---|
| R7 | 976 | kΩ | 1% |
| R8 | 976 | kΩ | 1% |
| R9 | 976 | kΩ | 1% |
| R10 | 20 | kΩ | 1% |
| R11 | 4.7 | kΩ | |
| R12 | 2.2 | kΩ | 1% |
| R13 | 36.5 | kΩ | |
| R14 | 7.68 | kΩ | 1% |
| R15 | 7.68 | kΩ | 1% |

| | |
|---|---|
| R16 | 24Ω |
| R17 | 220Ω |

| | | | |
|---|---|---|---|
| R18 | 143 | kΩ | 1% |
| R19 | 1.2 | kΩ | |
| R20 | 4.7 | kΩ | |

| | |
|---|---|
| Value | Internal voltage |

| | | | | |
|---|---|---|---|---|
| C5 | 1 | μF | 25 | V |
| C6 | 4.7 | nF | 200 | V |
| C7 | 220 | nF | 50 | V |
| C8 | 4.7 | nF | 200 | V |
| C9 | 4.7 | nF | 200 | V |
| C10 | 1 | μF | 25 | V |
| C11 | 1 | nF | 200 | V |
| C12 | 330 | nF | 50 | V |
| C13 | 220 | nF | 630 | V |
| C14 | 6.2 | nF | 1.6 | kV |
| C15 | 47 | pF | 1.5 | kV |
| C16 | 47 | μF | 35 | V |

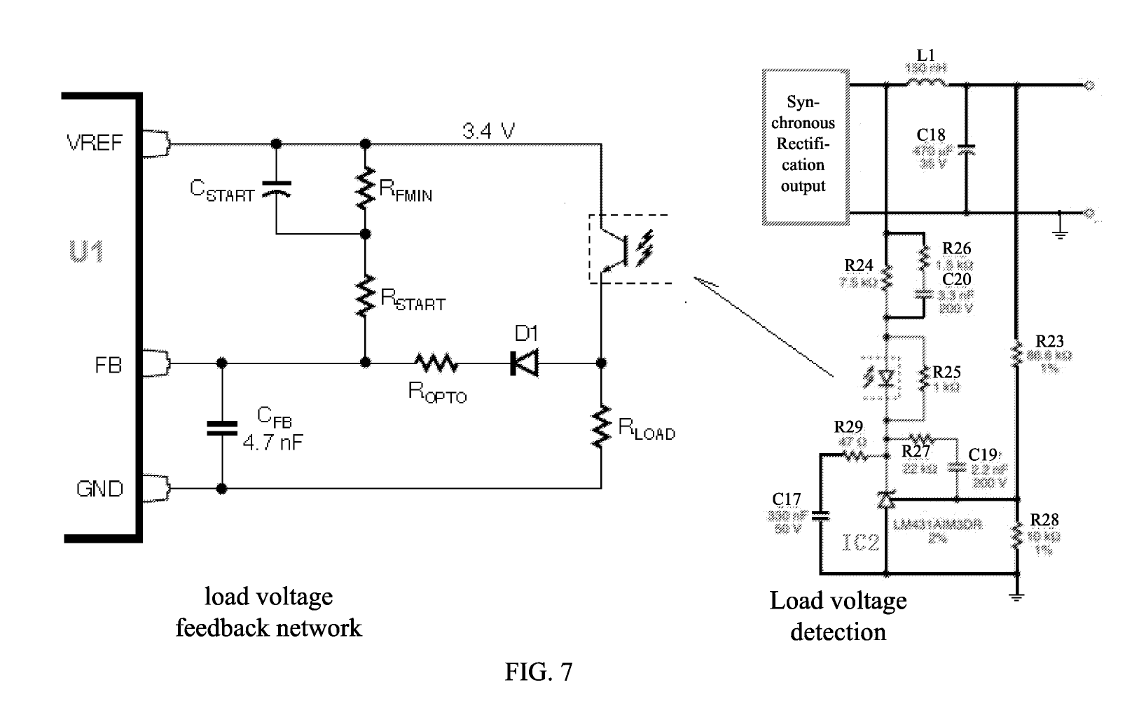

FIG. 7 is a diagram of an embodiment of a sensing circuit for the secondary output voltage and the FB feedback pin.

Feedback pin FB is a pin with stabilized voltage. It has a characteristic of a Thévenin's equivalent circuit with a rated voltage of about 0.65V and a resistance of about 2.5 kΩ. Under normal working conditions, it absorbs current. During shut off time of automatic restart, and the clock delay period before start, it will internally pull up voltage to VREF, so as to discharge the soft start capacitor Cstart in (equivalent to C7 in FIG. 6). The current that enters the pin determines the working frequency, that is, the switching frequency. The greater the current, the greater the switching frequency, so as to reduce the LC resonance output voltage. In a typical application, the optocoupler to VREF pin pulls up the voltage on the feedback pin FB through the resistor network. When the output voltage rises, the optocoupler acts as a current source to inject current into the feedback pin FB, so as to increase the current on the feedback pin FB. The resistor network among the optocoupler, the feedback pin FB and VREF pin determines the minimum and maximum feedback pin current (thus determines the minimum and maximum working frequency). The optocoupler can control the current on the feedback pin FB during the duration that the current ranges from cut-off to saturation. The resistor network also includes soft start timing capacitor Cstart (see FIG. 7).

The network settings should be lower than the minimum frequency conversion control circuit U1 power under the minimum input voltage required by the frequency. In FIG. 7, this is decided by Rfmin and Rstart, and when the light coupling device as current feedback pin is decided by the two resistances. Under normal working conditions, Cstart is negligible.

Matching Load

Converter U1 is variable frequency resonance converter. In a smaller range, when the load is reduced, the output voltage increases, therefore feedback current on the feedback pin FB increases, and the frequency increases. Refer to the resonance curve shown in FIG. 17B, when the operational region is on the right side of the resonance point—the higher the frequency, the lower the gain—thus the output voltage is reduced accordingly, which achieves the effect of stable voltage and load matching. When the converter U1 works at a series resonance frequency, the frequency changes slightly, if at all, with the change of load. When the voltage ramps down (minimum input voltage) at full load, the working frequency will reach the required minimum working frequency (close to the resonance point).

The parameters for resistance, capacitance and inductance shown in FIG. 7 are as below.

| | |
|---|---|
| Value | Accuracy |

| | | | |
|---|---|---|---|
| R23 | 86.6 | kΩ | 1% |
| R24 | 7.5 | kΩ | |
| R25 | 1 | kΩ | |
| R26 | 1.5 | kΩ | |
| R27 | 22 | kΩ | |
| R28 | 10 | kΩ | 1% |

| | |
|---|---|
| R29 | 47Ω |

| | |
|---|---|
| Value | Internal Voltage |

| | | | |
|---|---|---|---|
| C17 | 330 | nF | 50 V |
| C18 | 470 | μF | 35 V |
| C19 | 2.2 | nF | 200 V |
| C20 | 3.3 | nF | 200 V |
| CFB | 4.7 | nF | |

| | Value |
|---|---|
| L1 | 150 nH |

Further, zener diode in the load voltage detection circuit, shown in FIG. 7 can use the general 431 type.

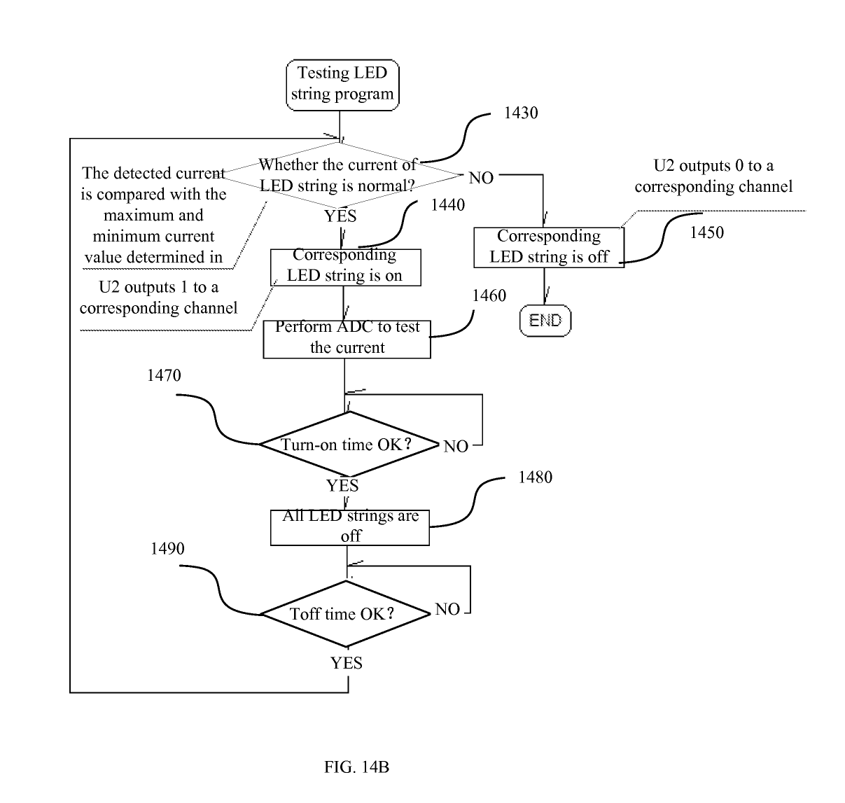

FIG. 15 is a method flow chart of controller U1. For U1, the hardware circuit power input and hardware detection management includes: provide the about 12V aiding power to VCC and VCCH power supply pin. When the input voltage is greater than the VCC pin voltage threshold, U1 starts. When the input voltage is lower than the VCC pin circuit off threshold, U1 does not work, and all the outputs are closed. When the input voltage is greater than the VCCH pin circuit threshold, Q1 starts working status.

For a software part, shown in FIG. 15, first the hardware and parameter variables of the controller U1 are initialized in block 1500. Then the controller U1 determines whether the input DC power supply (about 380V) is normal in block 1510. If abnormal, then the controller U1 is closed in block 1520, to prevent that the controller U1 from being damaged. If normal, then the controller U1 determines whether working frequency fs is less than the maximum frequency threshold (fstop) in block 1530. If less than the maximum frequency threshold, then the controller U1 continues to determine whether the working frequency is greater than the minimum frequency threshold (fstart) in block 1540. If fs is less than or equal to the minimum frequency threshold value, or if fs is greater than or equal to the maximum frequency threshold, simultaneously shut off both Q1 and Q2 in block 1550. If fstart<fs<fstop, then the Q1 and Q2 are turned on in block 1560.

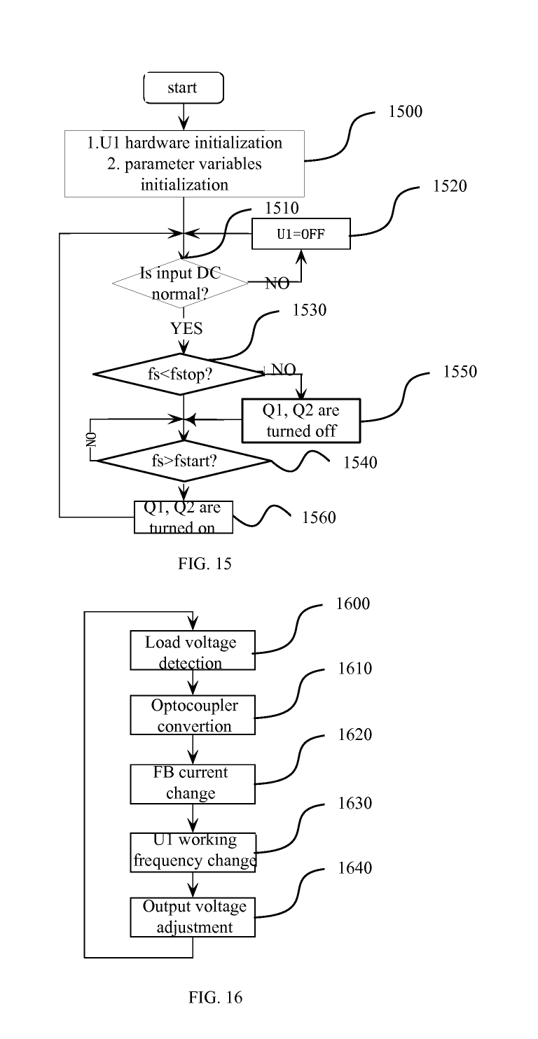

FIG. 16 is a flow chart illustrating a method of adjusting output power. First the method detects in block 1600 the load voltage, that is, the feedback voltage. Then the optocoupler converts in block 1610 the feedback voltage to feedback current. Then in block 1620, the feedback current changes according to the change of feedback voltage. Then, the controller U1 changes in block 1630 the working frequency of the resonance unit according to the feedback current, so as to change the output voltage in block 1640. If the working current is greater than the current limit threshold, the controller U1 increases the working frequency so as to reduce the output voltage, instead of immediately closing Q1 and Q2.

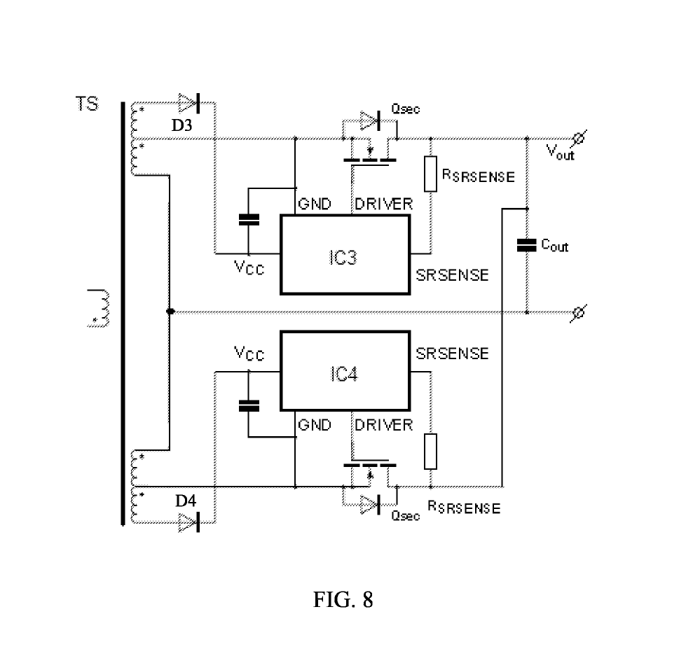

FIG. 8 is a circuit diagram illustrating an embodiment of the rectifier circuit. FIG. 8 will be described in combination with FIGS. 4 and 5. The IC3 in FIG. 8 is equivalent to the IC3 in FIGS. 4 and 5, and IC4 in FIG. 8 is the equivalent of IC4 in FIGS. 4 and 5. As shown in FIG. 8, the IC3 and IC4 respectively have an Srsense input port and a Driver output respectively. Rsresense in FIG. 8 is equivalent to R5 and R6 in FIG. 5. Qsec is equivalent to Q3 and Q4 in FIG. 5. D3 is equivalent to D1 in FIG. 5, and D4 is equivalent to D2 in FIG. 5.

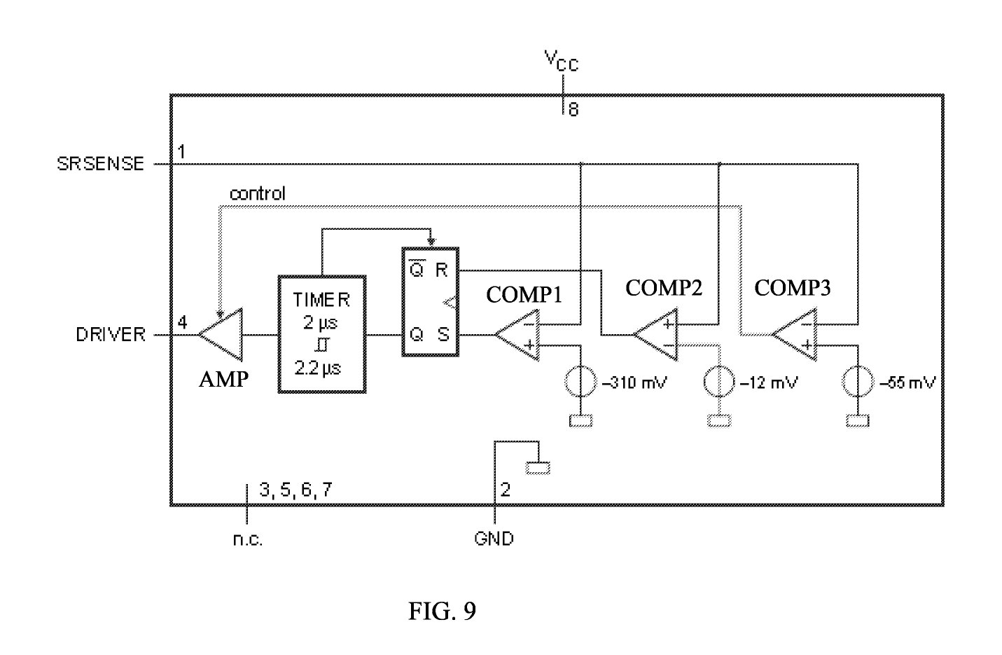

FIG. 9 is an internal block diagram of the chip IC3 and IC4 shown in FIG. 8. IC3 and IC4 are the same synchronous rectifier chips. Chip IC3 and IC4 each comprise a timer, a RS trigger, a first comparator COMP1, a second comparator COMP2, a third comparator COMP3, and an amplifier AMP. One input port of each of the first comparator COMP1, the second comparator COMP2 and the third comparator COMP3 is configured to receive an input voltage. The other input port of each the first comparator COMP1, the second comparator COMP2 and the third comparator COMP3 is configured to obtain a first voltage threshold, for example, about −310 mV, a second voltage threshold, for example, about −12 mV, and a third voltage threshold respectively, for example, about −55 mV. An output port of the first comparator COMP1 is connected to an S port of the RS trigger. An output port of the second comparator COMP2 is connected to an R port of the RS trigger. An output port of the third comparator COMP2 is connected to the first input port of the amplifier AMP. An input port of the timer is connected to a Q port of the RS trigger. The first output port of the timer is connected to a control port of the RS trigger. A second output port of the timer is connected to a second input port of the amplifier AMP. The timer is hysteresis.

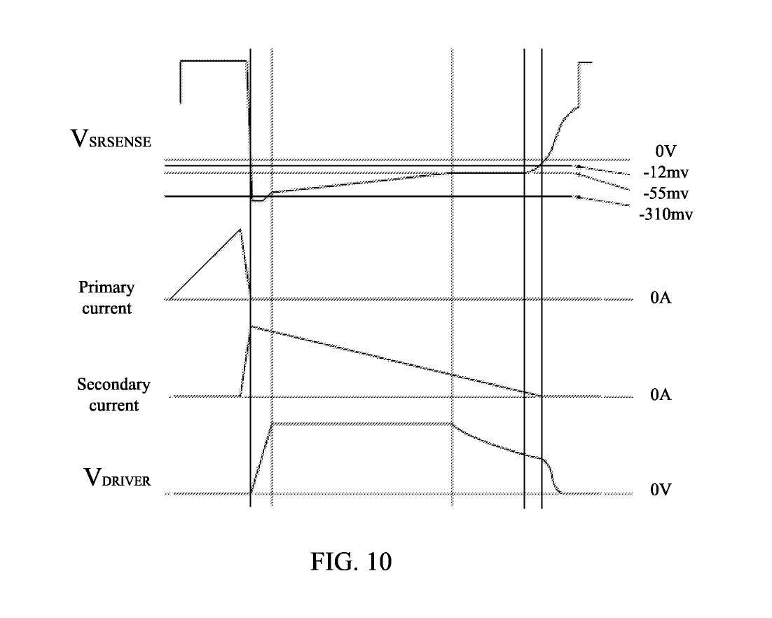

FIG. 10 is a block diagram illustrating an embodiment of the lighting circuit.

When the rectifying circuit is working, its operation principle is as follows: when the SRSENSE pin senses negative voltage (typical value of about −310 mv), the driver outputs high voltage level, and the external MOSFET Qsec is on. After the SRSENSE pin voltage rises to about −55 mv, the driving output voltage will maintain the pin voltage at about −55 mv; When SRSENSE pin voltage rises to about −12 mv, the drive output will be pulled down to the ground immediately.

After the synchronous rectifier MOSFET is on, input signal of SRSENSE pin will be interrupted for about 2 ms, in order to prevent wrong turn-off caused by secondary impulse current with high-frequency.

When the SRSENSE pin voltage is about −55 mv, the driver output voltage will be immediately reduced. When the switch current is zero, the external power switch Qsec (that is equivalent to Q3 and Q4 in FIG. 5) will turn off immediately. When SRSENSE pin voltage equals about −12 mv, zero current is detected.

When the Timer detects a secondary pulse to be less than two microseconds (μs) (typically), the driver output shuts down, which causes the circuit to work at a small duty cycle. When the secondary pulse increases to more than 2.2 microseconds (μs), the driver output reopens. Those having ordinary skill in the art should appreciate that the above numericals (for example, the 2 microseconds and 2.2 microseconds) are for reference only, and those having ordinary skill in the art can adjust the actual values according to actual application.

The driving capacity of the gate driving circuit for the external power MOSFET Qsec includes typical drive current of about 250 mA and typical reverse current of about 2.7 A. The driving capacity can achieve quick open and shut off with high-efficiency. The output driving voltage is limited to about 10 v. The driving voltage can drive all of the MOSFET with minimum turn-on resistance.

At startup (VCC<V startup) and under-voltage lockout, the output driving voltage is immediately pulled low.

The rectifier circuit may have at least the following advantages:

Precise synchronous rectifying function; wide voltage power supply (about 8.6 V˜about 38 V); Accurate internal reference voltage (accuracy of 1%); 10V voltage with high driving capacity and low turn-on resistance can drive all the MOSFET; Green features: low current consumption, high system efficiency from no load to full load; Protection features: under-voltage protection, when VCC voltage reaches about 8.6 V (typical), under-voltage lockout is removed, and the synchronous rectifier circuit is activated. When the VCC voltage drops below 8.1V, the IC enters under-voltage lockout state again, and the synchronous rectifier outputs low level voltage.

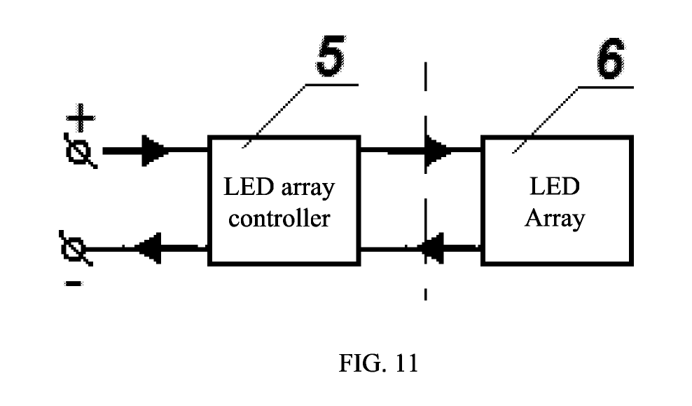

FIG. 11 is a diagram illustrating an embodiment of the LED circuit. The lighting circuit includes a LED array controller 5 and a LED array 6.

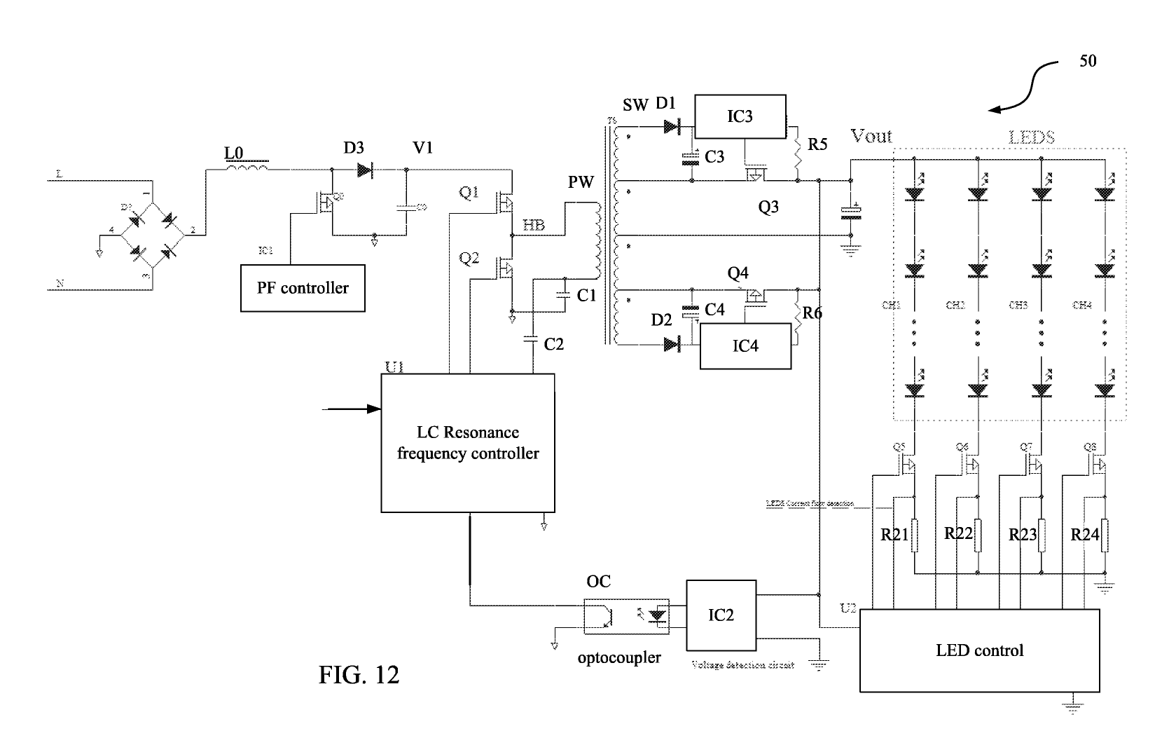

FIG. 12 is a diagram illustrating an embodiment of the circuit of the LED device including a driving circuit. The lighting device 50 includes the driving circuit. The driving circuit further includes a transformer TS, a capacitor C1, and a controller U1. The lighting device also includes a plurality of LED elements connected to the secondary side of the driving circuit. These LED elements are arranged in several groups, namely into several columns, and the several groups are connected in parallel, wherein the LED elements work between about a rated working current and about a peak pulse current. Alternatively, the LED elements may work at about the peak pulse current. Generally speaking, the peak pulse current of the LED elements is equal to the peak current, and is 3 times that of the normal working current. The normal working current comprises the rated working current.

The number of the LED elements in the LED array can be one high-power (integrated optical source, COB etc.) or multiple. The maximum total power of the LED elements can be up to hundreds of watts. Series connection (i.e., channel CH1, CH2, . . . ) or parallel connection (column number of like strings) can be adopted according to the power parameters of the power supply and LED element parameter. The parameter of each string is the same and the operating principles are similar as well. LED array may be designed as a surface, instead of a point. The LED array may be well ventilated, and the LED elements are first connected in series, then the strings are connected in parallel.

When many LED elements are needed to build a high-power LED array LED, a plurality of channels are formed first by being connected in series. (In the embodiment, there are four channels CH1-CH4). Each array is controlled independently. Differentiation will be created if all of the four strings are connected in parallel, which will result in additional heat dissipation.

Q5˜Q8 in FIG. 12 is the current driver for the controller U2. R21, R22, R23 and R24 are the sample resistors employed by U2 to detect the value of turn-on current of each channel. Sample resistors can also function as the current-limiting resistor for respective channels CH1, and CH2. The sample resistors can be adjusted to determine the maximum current. The current of each channel can take the value of peak pulse current value of the LED product parameter provided by the manufacturer. Advantage of using the peak pulse current value is to establish a thermal power fluctuation mode, and heat fluctuation transfer is far better than the constant current heat transfer. Under an appropriate enough frequency, and by taking advantage of the human eye's ability to sense the brightness of an object, the thermal fluctuation mode substantially reduces power consumption, while achieving the same effect.

In addition to detecting the current of each channel (CH1 and CH2, as examples), and protecting each channel, the controller U2 further determines the on/off time period of the LED array to eliminate flickers, and determines the value of off time Toff. The off-time Toff determines the operating temperature and overall brightness of the LED array. When the LED device works discontinuously, and when the LED elements are instantly on, the LED elements will have the maximum brightness (when operating at the peak pulse current) which can effectively enhance the subjective brightness of sensitization of human eyes so as to be more energy-efficient. The enhanced instant temperature difference will facilitate conducting the heat to the outside because the conductive heat is proportional to the temperature difference. Distortion-less dimming is easy to be achieved through increasing a few elements, which greatly reduces the light attenuation and aging of the LED elements so as to enable the LED device lifetime to be normally 50,000˜100,000 hours. If the operational parameters of the circuit and the space structure of the LED device are carefully adjusted, the LED device can use quite few nonferrous metal heat sinks, or even none at all.

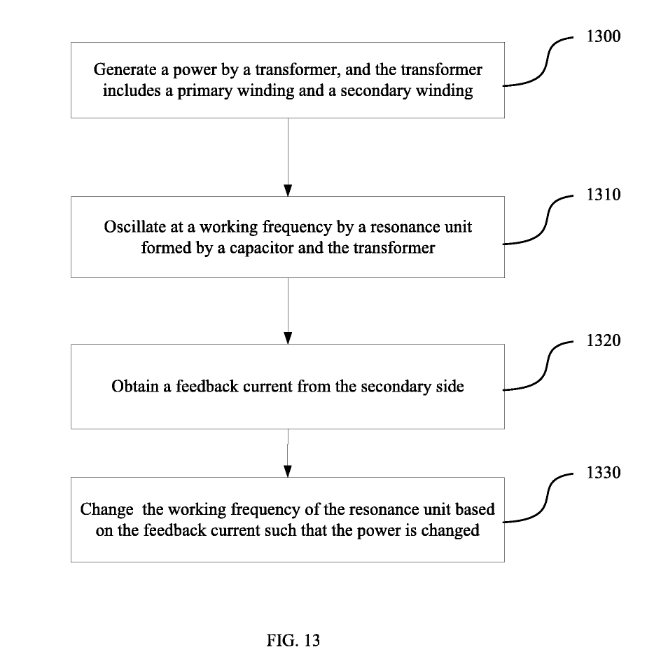

FIG. 13 is a diagram illustrating an embodiment of a driving method. The driving method can be used to adjust power dissipation. The method comprises generating in block 1300, a power by a transformer. The transformer includes a primary winding and a secondary winding, and the secondary winding is located in a secondary side; oscillating, in block 1310, at a working frequency by a resonance unit formed by a capacitor and the transformer; obtaining, in block 1320, a feedback current from the secondary side, and changing in block 1330, the working frequency of the resonance unit based on the feedback current such that the power is changed.

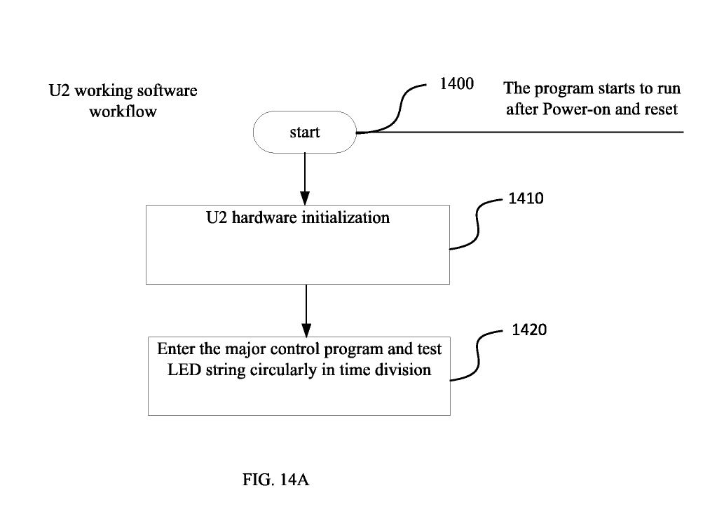

FIGS. 14A and 14B are flow charts illustrating an embodiment of a method of light controlling. U2 is equivalent to LED control chip in FIG. 12. It can be a programmable single-chip MCU, and is used to control the LED array. If the circuit works normally, the LED array opens and closes periodically. The working cycle can be set when programming, and the maximum cycle should keep the LED array flicker free. Working cycle refers to that the LED array works in a pulse mode, and the LED array is not always on, but on and off periodically, and the turn-off time is Toff. As long as the pulse frequency is high enough (>about 50 Hz), there would be no flicker.

FIG. 14A shows a procedure of U2 after it is powered on and reset:

The method starts in block 1400, then, in block 1410, hardware of controller U2 is initialized, and then in block 1420, the process enters major control program, and tests LED string circularly in time division.

The method of determining the working temperature of the LED array in LED device comprises a fixed method and an automatic management method:

1) Manually Fixed Method

When the products are manufactured in a factory, different turn-off time Toff is selected according to the environmental temperature, so as to measure the working temperature when the LED array are stable, that is, Toff time of LED elements is determined according to the working temperature. Toff value can be programmed in chips.

2) Automatic Management Method

When the products are manufactured in a factory, they are equipped with a temperature sensor in the circuit, and the Toff value is automatically determined by the chip program according to the temperature of LED element feedback by the temperature sensor, so as to determine the overall temperature of the LED device.

Current detection for the LED array (each channel CH1 and CH2 or, . . . ): controller U2 is connected to resistors R21, R22, . . . , which are respectively sampling resistors corresponding to the respective channels CH1, CH2, . . . , that is each analog-digital conversion channel ADC1, ADC2, . . . corresponding to U2. When U2 opens each channel CH1, CH2, . . . the current tested from each channel by U2 is treated as follows:

U2 compares the current obtained through corresponding analog-to-digital conversion ADC channel to the maximum pulse current (that is, the peak pulse current) of the LED string. The maximum current is the maximum pulse current value that channels CH1 or CH2, . . . allow (which can be looked up in the LED element parameter table). The maximum pulse current value generally is three times the normal working current.

The measured current is compared with the maximum pulse currents of LED string. When the measured current is larger than the maximum pulse current value of the LED strings, the channel is closed, so as to prevent the LED strings from over current and electrical shorts.

When the LED string is on, the maximum current is three times the normal operating values (which can be looked up in the LED element information); and the minimum current value can be the normal working value. Software engineers can program to input in advance.

Alternatively, the LED string turn-on time and turn-off time value Toff can be an experimental value, which can be input with program by a software engineer in advance.

FIG. 14B shows a flow chart of an embodiment method of controlling the LED. In FIG. 14B, the method first determines, in block 1430, whether the LED string current is normal; by comparing measured current with maximum and minimum current values during programming. If the current is normal, the method turns on the corresponding LED string in block 1440, and supplies power to the gate of the corresponding LED string. Otherwise, the method turns off the corresponding LED string in block 1450; U2 sets the output of the corresponding CHANNEL (CHANNEL) to 0. After turning on the corresponding LED string, the method continues to perform ADC to test current in block 1460, and then it determines whether the turn-on time meets a predetermined condition in block 1470, such as whether the time reaches a predetermined duration, such as about 2 ms. If the turn-on time meets the predetermined condition, then all LED strings are closed in block 1480, and then the method determines whether a turn-off time Toff meets a predetermined condition in block 1490, such as whether it reaches a predetermined duration, such as 3 ms. If the turn-off time meets the predetermined condition, then the method goes back to determine whether the LED string current is normal in block 1430. If the turn-off time Toff does not meet the predetermined condition, the method continues to determine whether the closed time Toff meets the predetermined conditions in block 1490. If the turn-on time does not meet the predetermined condition, then the method returns to continue to determine whether the turn-on time meets the predetermined condition in block 1470.

Optionally, if the period for turn-on and turn-off is set, then the process of determining the turn-on time and turn-off time can be omitted.

Although the present invention has been described with reference to specific exemplary embodiments, the present invention is not limited to the embodiments described herein, and it can be implemented in form of modifications or alterations without deviating from the spirit and scope of the appended claims. Accordingly, the description and the drawings are to be considered in an illustrative rather than a restrictive sense.

From the foregoing, it will be appreciated that specific embodiments of the technology have been described herein for purposes of illustration; however various modifications can be made without deviating from the spirit and scope of the present invention. Accordingly, the present invention is not restricted except in the spirit of the appended claims.

Other variations to the disclosed embodiments can be understood and effected by those skilled in the art in practicing the claimed invention, from a study of the drawings, the disclosure, and the appended claims. In the claims the word “comprising” does not exclude other elements or steps, and the indefinite article “a” or “an” does not exclude a plurality. Even if particular features are recited in different dependent claims, the present invention also relates to the embodiments including all these features. Any reference signs in the claims should not be construed as limiting the scope.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made without deviating from the spirit and scope of the present invention. Moreover, features of one embodiment may be incorporated into other embodiments, even where those features are not described together in a single embodiment within the present document. Accordingly, the invention is described by the appended claims.

1-6. (canceled)

7. A driving circuit, comprising:
a transformer including a primary winding and a secondary winding, the secondary winding being located on a secondary side and configured to generate a power;
a first capacitor connected in series to the primary winding, wherein the first capacitor and the transformer are configured to form a resonance unit;
a first controller configured to obtain a feedback current from the secondary side, and change the working frequency of the resonance unit based on the feedback current so as to change the power;
wherein the secondary side further comprises a first rectifier connected to the secondary winding, and the first rectifier is configured to cut off the power when a voltage on the first rectifier is lower than a first voltage threshold, wherein the first rectifier comprises a Metal-Oxide-Semiconductor Field Effect Transistor.

8. The driving circuit of claim 7, wherein the secondary side further comprises a second controller; configured to turn on the first rectifier if the voltage during a duration is larger than a second voltage threshold, and the duration is larger than a time threshold.

9. The driving circuit of claim 8, wherein the second controller further comprises a timer, a RS trigger, a first comparator, a second comparator, a third comparator, and an amplifier, wherein
one input port of each of the first comparator, the second comparator and the third comparator is configured to receive an input voltage, the other input port of the first comparator, the second comparator and the third comparator is configured to obtain a third voltage threshold, a fourth voltage threshold, and a fifth voltage threshold respectively, wherein an output port of the first comparator is connected to a S port of the RS trigger, an output port of the second comparator is connected to a R port of the RS trigger, an output port of the third comparator is connected to a first input port of the amplifier, an input port of the timer is connected to a Q port of the RS trigger, a first output port of the timer is connected to a control port of the RS trigger, a second output port of the timer is connected to a second input port of the amplifier.

10. The driving circuit of claim 7, wherein the secondary side further comprises a first diode, a third capacitor, wherein an anode of the first diode is connected to a first tap of the secondary winding, the third capacitor is connected between a cathode of the first diode and a second tap of the secondary winding, and the first rectifier is connected to a connection point of the second tap and the third capacitor.

11. The driving circuit of claim 7, wherein the secondary side further comprises a second rectifier connected to the secondary winding, wherein the first rectifier and the second rectifier are alternately on to perform a full wave rectification.

12-23. (canceled)

24. A driving circuit, comprising:
a transformer including a primary winding and a secondary winding, the secondary winding being located in a secondary side and configured to generate a power;
a first capacitor connected in series to the primary winding, wherein the first capacitor and the transformer are configured to form a resonance unit;
a first controller configured to obtain a feedback current from the secondary side, and change a working frequency of the resonance unit based on the feedback current; and wherein
the resonance unit is configured to oscillate on the changed working frequency so as to output changed power;
a plurality of LED elements connected to the secondary side of the driving circuit, wherein the LED elements work in a range between about a normal working current and about a peak pulse current;
wherein the secondary side further comprises a first rectifier connected to the secondary winding, and the first rectifier is configured to cut off the power when a voltage on the first rectifier is lower than a first voltage threshold, wherein the first rectifier comprises a Metal-Oxide-Semiconductor Field Effect Transistor.

25. The lighting device of claim 24, wherein the secondary side further comprises a third controller, configured to turn on the first rectifier if the voltage during a duration is larger than a second voltage threshold, and the duration is larger than a time threshold.

26. The lighting device of claim 25, wherein the third controller further comprises a timer, a RS trigger, a first comparator, a second comparator, a third comparator, and an amplifier, wherein
one input port of each of the first comparator, the second comparator and the third comparator is configured to receive an input voltage, the other input port of the first comparator, the second comparator and the third comparator is configured to obtain a third voltage threshold, a fourth voltage threshold, and a fifth voltage threshold respectively, wherein an output port of the first comparator is connected to a S port of the RS trigger, an output port of the second comparator is connected to a R port of the RS trigger, an output port of the third comparator is connected to a first input port of the amplifier, an input port of the timer is connected to a Q port of the RS trigger, a first output port of the timer is connected to a control port of the RS trigger, a second output port of the timer is connected to a second input port of the amplifier.

27. The lighting device of claim 24, wherein the secondary side further comprises a first diode, a third capacitor, wherein an anode of the first diode is connected to a first tap of the secondary winding, the third capacitor is connected between a cathode of the first diode and a second tap of the secondary winding, and the first rectifier is connected to a connection point of the second tap and the third capacitor.

28. The lighting device of claim 24, wherein the secondary side further comprises a second rectifier connected to the secondary winding, wherein the first rectifier and the second rectifier are alternately on to perform a full wave rectification.

29-37. (canceled)
